(19) United States
(12) Patent Application Publication
(10) Pub. No.: US 2013/0047671 A1
(43) Pub. Date: Feb. 28, 2013

(54) APPARATUS AND METHOD FOR FORMING GLASS SHEETS

(71) Applicant: Jeffrey T. Kohli, Corning, NY (US)

(72) Inventor: Jeffrey T. Kohli, Corning, NY (US)

(21) Appl. No.: 13/219,824

(22) Filed: Aug. 29, 2011

(51) Int. Cl. C03B 17/06; C03B 33/02; C03B 32/00; C03B 25/00; C03B 18/02; C03C 21/00

(52) U.S. Cl. 65/30.13; 65/83; 65/95; 65/111; 65/182.1; 65/182.2

(57) ABSTRACT

Disclosed is a method of reducing the compaction of glass formed by a down draw process. The glass may be a glass sheet or a glass ribbon. Once the glass is formed, it is thermally treated on a molten metal bath for a time and at a temperature effective to reduce the fictive temperature of the glass below a predetermined level. In one embodiment, a glass ribbon is formed in a fusion process and the glass ribbon redirected onto a molten metal bath where the ribbon is thermally treated.

### BACKGROUND

1. Field

The present invention relates to the thermal treatment of glass manufactured using a process such as the fusion draw process, or other processes which typically yield discrete sheets from a viscous ribbon of a glass-forming melt.

2. Technical Background

Processes like the fusion-draw process yield sheets of glass that have been cooled relatively rapidly during the forming process and specifically past the annealing point and through the glass transformation temperature range. The benefit of rapid cooling is process throughput and/or the ability to limit the footprint or height of the manufacturing process. However, a relatively rapid cooling process yields a glass that has a relatively open atomic structure, or high molar volume, compared to a glass-forming ribbon that is cooled slowly through the glass transformation temperature range. Moreover, for processes like fusion draw that have a fixed melting and/or flow rate, the formation of thinner glass necessarily translates to an increased cooling rate; i.e. glass comes off the draw faster, and has less heat capacity. This means the glass sheets, or smaller glass articles cut from a mother sheet, may compact, densify, or otherwise achieve a lower molar volume when the glass is subsequently re-heated during thermal processing (e.g. during application of ITO or coatings, when bonded to silicon, or when processed in a molten salt bath used for chemical strengthening). Such compaction or relaxation of the glass structure in post-forming thermal treatments can lead, for example, to unacceptable sheet dimensional changes or a limitation of compressive stress that might otherwise be achieved in a chemical strengthening (ion-exchange) process. To minimize compaction, dimensional change, or structural relaxation that may occur in post-processing of the sheet, it is known that thermal treatments or “annealing” may be used to pre-compact or relax the glass structure prior to the desired subsequent thermal processes such as those mentioned previously. Relaxation in this context refers to the gradual attainment of an equilibrium atomic structure that the viscous material was not given sufficient time to achieve because it had been cooled too rapidly. Methods practiced by glass manufacturers or LCD panel-makers have included thermal treatment of the sheets in a box furnace or annealing lehr in either vertical or horizontal orientations. Unfortunately, these processes may lead to deformation of the sheet, abrasion or surface damage due to inadvertent contact with hard materials, or adhesion of glass or other foreign particles to the surface of the glass. Abrasion or adhesion of particles on the surface is particularly detrimental when the final product application is suited to a pristine, as-drawn glass surface, rather than a surface that is subsequently ground to thickness and polished. This surface damage or adhered particles may yield optical defects or become strength-limiting flaws.

### SUMMARY OF THE INVENTION

When glass that has been cooled relatively rapidly is placed in an ion-exchange bath at elevated temperature, the atomic structure will relax, the degree of which is dependent upon temperature and time, as well as the composition of the glass and the rate at which the glass was cooled from the melt. In an ion-exchange process for glass sheets, the intent is to build compressive stress into the sheet surface. If the ion exchange process is performed at a high temperature, the glass structure relaxes in the ion-exchange bath and it will therefore be difficult to build-in the desired stress because the stress is being relieved. This structural relaxation limits the degree to which a desirably high compressive stress can be created in the surface of the glass, since the relaxation is constantly competing against the process intended to build-up compressive stress at the surface. Stuffing larger ions, such as potassium ions, into smaller ionic sites, such as sodium sites (during ion-exchange) in a pre-relaxed, denser structure allows the glass to build-in more compressive stress at the surface.

While the pre-relaxation or compaction of the glass may be conducted in common box-type furnaces, or annealing lehrs, the glass is subject to distortion due to gravitational forces and contact with hard refractory materials that can damage the aesthetics of the surface or create strength-limiting flaws.

Disclosed herein is a process that enhances the value of a glass sheet by reducing the degree of compaction, structural relaxation, or dimensional change incurred by the glass sheet in subsequent thermal processing of the sheet and/or product (e.g. when coatings are applied to the glass, the glass is thermally bonded to another material, or when the glass sheet/product is chemically strengthened). One application of the process is directed to discrete sheets that have been cooled relatively rapidly through the transformation temperature range of the glass. However, the process may be applied in a continuous fashion to an extended ribbon (i.e. more than several meters in length) of glass delivered from a down draw process, or the like. In the latter case, segmentation of the ribbon into discrete sheets occurs upon completion of the extended heat treatment process. The process, in its broadest terms, involves controlled cooling of glass sheets that have been formed to near-net shape (thickness, length and width) or a ribbon that has been formed to a desired thickness and width prior to being delivered to a molten metal bath having a temperature range that enables the glass sheet to be pre-compacted, or otherwise heated to an extent where the fictive temperature of the glass is substantially reduced. Such an approach is particularly well suited to a down draw process such as the fusion down draw process.

Down draw processes are generally hampered by the comparatively short distance between where the ribbon is formed at the top of the draw, and the bottom of the draw where the glass has solidified and is cut into the desired shape. That is, there are practical limits to the physical height of the draw and the length of the glass ribbon. Stability of the glass ribbon is paramount, especially as the glass is passing through the glass transition temperature region. The higher the draw and therefore the longer the time during which the glass ribbon is suspended, the more difficult it becomes to maintain a stable forming process, particularly when one considers that the glass produced for display-type applications is typically 2 mm or less in thickness, and more typically less than 1 mm in thickness. Thus, the glass ribbon transits the entire draw height in a matter of minutes, affording very little time to treat the glass in a conventional annealing cycle that might last for tens of minutes or even hours.

The method disclosed herein allows the glass ribbon, or in some instances an individual glass sheet, to be floated in a horizontal orientation on a denser, molten metallic liquid that maintains the ribbon, or the individual glass sheet, in a flat and otherwise undistorted shape. Moreover, when the glass ribbon or sheet is floated and its structure or fictive temperature is appropriately adjusted, it is not subject to the degree of distortion that may be incurred by, for example, hanging the sheets in a furnace or lehr, or supporting the sheets in a fixture or container, after they have been segmented from the ribbon. Likewise, the surface of the ribbon or sheet is not substantially marred by contacting a hard support material (e.g. setter tile) if the ribbon or sheet was thermally processed in a horizontal orientation. The process described herein is particularly well-suited to glass that is relatively thin, e.g. equal to or less than 2 mm in thickness, equal to or less than 1 mm in thickness, or even equal to or less than 0.7 mm in thickness. The advantage of thin ribbon or sheet is that it becomes increasingly more flexible as the thickness decreases. A thinner ribbon of glass may be turned from a vertical orientation using a catenary device that conveys the ribbon through a predetermined arc from a vertical to a horizontal orientation. Such a catenary device should hold and/or convey the ribbon at the extremes of its width, e.g. in the bead area of fusion-drawn glass. Alternatively, the ribbon may be turned in the course of an arc using an air bearing to the forward or leading edge of a molten metal bath. In both cases, the so-called quality area of the ribbon or sheet is untouched by mechanical devices as it is conveyed from a vertical to a horizontal orientation. As used herein, the term “quality area” refers to the portion of the glass sheet or ribbon that is eventually incorporated into a final device. In many processes edge portions of the ribbon or sheet that are contacted, termed non-quality areas, are later removed, either because the contact brings with it potential for damage, or because the non-quality areas may suffer from unacceptable dimensional attributes. In any event, the glass ribbon remains in an enclosure from the vertical position through the horizontal position, thereby eliminating particulate generated while segmenting the ribbon, or in the ambient air, from traveling upward and adhering to the glass because of a chimney effect.

Accordingly, in one embodiment a method of forming a glass sheet is disclosed comprising flowing molten glass from a forming body in a downdraw process to form a glass ribbon comprising a viscous portion having a viscosity equal to or greater than 10⁸ Poise; redirecting the viscous portion to a second direction different from the first direction; supporting the redirected viscous portion on a bath of molten metal, wherein a second viscosity of the viscous portion as it enters onto the bath of molten metal is equal to or greater than about 10⁹ Poise, cooling the viscous portion to a third viscosity equal to or greater than about 10¹⁴ Poise as the viscous portion traverses the bath of molten metal to form an elastic portion; and separating the elastic portion from the ribbon to form a glass sheet. The viscous portion may be supported, for example, by an air bearing during the redirecting. Alternatively, the glass ribbon may be supported by rollers during the redirecting. In some embodiments the glass sheet may be supported by both rollers and an air bearing during the redirecting. Unlike conventional float processes where a viscous mass of molten glass enters onto the surface of the molten metal at a relatively low viscosity between about 10³-10⁵ Poise, the glass ribbon (or glass sheet in some embodiments) of the present invention enters onto the molten bath at a relatively high viscosity, equal to or greater than about 10⁹ Poise. The bath of molten metal may, for example, comprise tin. Alternatively, the bath of molten metal may further comprise lead, silver, copper, zinc or antimony, or a combination thereof.

In some embodiments, the individual glass sheet, or a glass sheet cut from the thermally treated ribbon, may be ion exchanged after the separating.

In another embodiment a method of thermally treating a glass sheet is described comprising providing a glass sheet, the glass sheet having a viscosity greater than 10⁹ Poise and supporting the glass sheet on a bath of molten metal, wherein the glass sheet is thermally treated for a time effective to reduce a fictive temperature of the glass sheet below a predetermined temperature. For example, the fictive temperature of the glass sheet may be reduced to a temperature between 230° C. and 750° C. as a result of the treatment, to a temperature between 300° C. and 650° C., or to a temperature between 400° C. and 650° C.

In still another embodiment, an apparatus for producing a glass sheet is disclosed comprising: a forming body, the forming body comprising a channel formed in an upper surface of the forming body for receiving molten glass, and converging forming surface that join at a root; a redirecting apparatus configured to redirect a glass ribbon descending from the root from a first direction to a second direction different than the first direction; a vessel containing a molten metal, such as tin, that supports the glass ribbon; and a cutting device positioned downstream of the molten metal-containing vessel and adapted to cut a glass sheet from the glass ribbon. The redirecting apparatus may comprise, for example, an air bearing. Alternatively, the redirecting apparatus may comprise rollers. And in some embodiments, the redirecting apparatus may comprise both an air bearing and rollers.

In some embodiments the molten metal may comprise a metal selected from the group consisting of tin, lead, silver, antimony, copper and zinc, or combinations thereof.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and constitute a part of this specification. The drawings illustrate various embodiments of the invention and, together with the description, serve to explain the principles and operations of the invention.

### BRIEF DESCRIPTION OF THE DRAWINGS

FIG. 1 is an elevational view of a exemplary fusion downdraw glass making process;

FIG. 2 is a cross sectional view of an embodiment according to the present invention wherein a glass sheet formed by a downdraw process is heat treated on a bath of a molten metal.

FIG. 3 is a cross sectional view of another embodiment according to the present invention wherein a glass ribbon formed by a downdraw process is heat treated on a bath of a molten metal.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

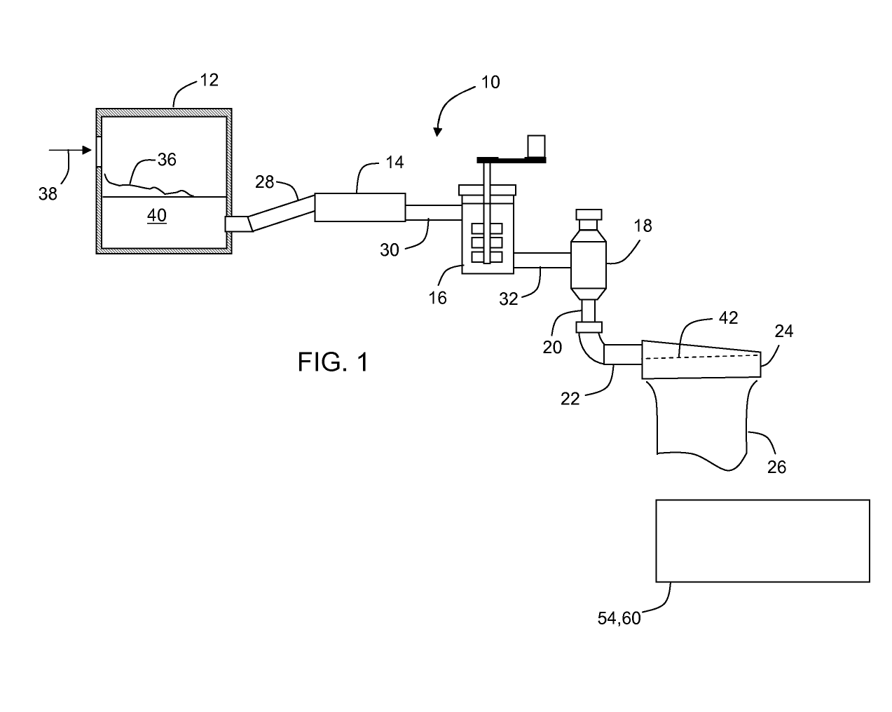

FIG. 1 illustrates an exemplary embodiment of a fusion glass making system 10 for forming a glass sheet comprising melting furnace 12, fining vessel 14, stirring vessel 16, receiving vessel 18, downcomer 20, inlet 22 and forming body 24 from which a thin ribbon 26 of a molten glass-forming material descends. Glass making system 10 further comprises various other vessels or conduits for conveying the molten glass-forming material, including a melter-to-fining vessel connecting tube 28, a fining vessel-to-stirring vessel connecting tube 30, and a stirring vessel-to-receiving vessel connecting tube 32. While the melting furnace and/or forming body are typically formed from a ceramic material, such as ceramic bricks comprising alumina or zirconia, the various vessels and piping therebetween often comprise platinum or an alloy thereof. Although the following description relates to an exemplary fusion downdraw process, such as the process illustrated in FIG. 1, the present invention is equally applicable to other variations of down draw glass making processes such as a single sided overflow process or a slot draw process, which basic processes are well known to those skilled in the art.

In accordance with the exemplary fusion process of FIG. 1, melting furnace 12 is provided with a batch material 36, as indicated by arrow 38, that is melted by the furnace to produce a glass-forming material (hereinafter molten glass 40). Molten glass 40 is conveyed from melting furnace 12 to fining vessel 14 through melting furnace-to-fining vessel connecting tube 28. The molten glass is heated to a temperature in excess of the furnace temperature in the fining vessel, whereupon multivalent oxide materials contained within the molten glass release oxygen that rises through the molten glass. This high-temperature release of oxygen aids in removing the small bubbles of gas within the molten glass generated by melting of the batch material.

The molten glass then flows from fining vessel 14 through fining vessel-to-stirring vessel connecting tube 30 into the stirring vessel 16 where a rotating stirrer mixes and homogenizes the molten glass to ensure an even physical and chemical consistency. The homogenized molten glass from stirring vessel 16 then flows through stirring vessel-to-receiving vessel connecting tube 32 and is collected in receiving vessel 18 and routed to forming body 24, through downcomer 20 and inlet 22, and thereafter formed into a glass ribbon.

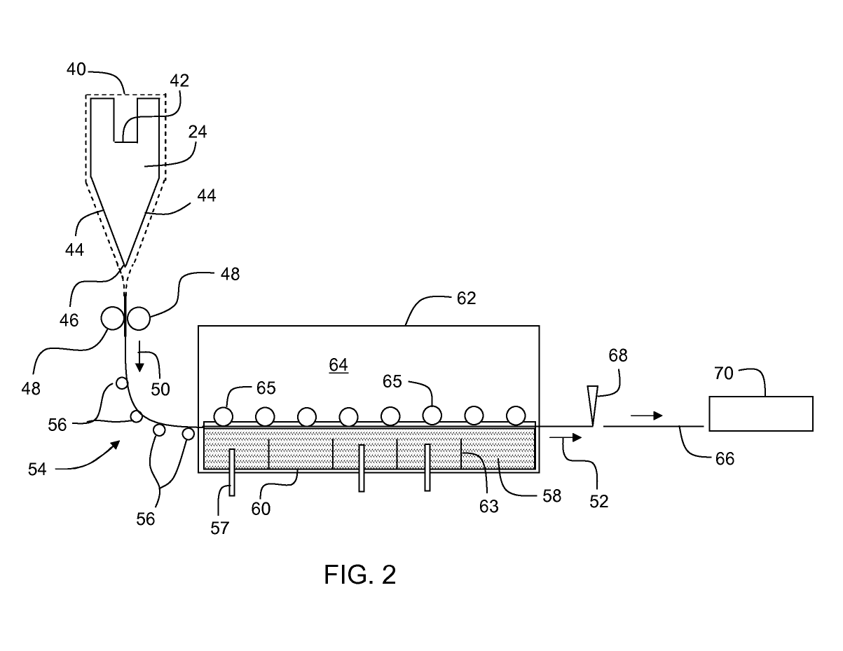

Forming body 24 comprises an open channel 42 positioned on an upper surface of the forming body and a pair of converging forming surfaces 44, best seen in FIG. 2, that converge at a bottom or root 46 of the forming body. The molten glass supplied to the forming body flows into the open channel and overflows the walls thereof, thereby separating into two individual flows of molten glass that flow over the converging forming surfaces. When the separate flows of molten glass reach the root, they recombine, or fuse, to form a single ribbon of viscous molten glass that descends from the root of the forming body. Various rollers 48 contact the viscous glass ribbon along the edges of the ribbon and aid in drawing the ribbon in a first, downward direction 50. Preferably the first downward direction is a vertical direction.

To redirect the ribbon into a second direction 52 different from the first direction, the fusion process of FIG. 1 further comprises redirecting apparatus 54 that turns the glass ribbon. Redirecting apparatus 54, shown in FIG. 2, is represented by rollers 56. Preferably the glass ribbon is turned by redirecting apparatus 54 through an angle of 90 degrees and second direction 52 is therefore horizontal. Preferably, a viscosity of glass ribbon 26 as it enters redirecting apparatus 54 is equal to or greater than about 10⁸ Poise, and equal to or greater than about 10⁹ Poise, and in some embodiments the viscosity of the glass ribbon as it enters the redirecting apparatus is equal to or greater than about 10¹⁰ Poise. The viscosity of the glass ribbon as it enters redirecting apparatus 54 is determined at least in part by the constraints imposed by such factors as the thickness of the glass ribbon, the thickness of the thickened edges (beads) of the ribbon, the method used to support the glass ribbon as it is redirected, the weight of the ribbon descending from the forming body and the flow rate of the molten glass from the forming body. For example, a higher viscosity glass ribbon, e.g. equal to or greater than 10¹⁰ Poise, may be suitable for a thin ribbon (e.g. equal to or less than about 0.6 mm). However, the viscosity of the glass ribbon should be sufficiently high as it is redirected that the glass ribbon is capable of maintaining its shape (e.g. thickness). Preferably, the redirecting apparatus does not contact the glass ribbon, or, in the event that contact is necessary, such as when rollers are used, contact is limited to the edge portions of the glass ribbon, for example along or adjacent to the bead regions of the glass ribbon positioned along the edges of the ribbon. As described briefly above, the beads are thickened areas of the ribbon that result in part from surface tension effects that cause the ribbon to pull inward from the edges of the ribbon.

In some embodiments redirecting apparatus 54 comprises an air bearing, wherein the glass ribbon is supported over a surface of the air bearing by a cushion of air that issues from a porous surface of the air bearing. The air bearing may, for example, include an arcuate surface that follows a catenary bend exhibited by the glass ribbon as it transitions from the first direction 50 to the second direction 52. Supporting the ribbon over an air bearing avoids physical contact between the air bearing surface and the glass ribbon, thereby minimizing opportunities for contact damage.

In still other embodiments, the glass ribbon may be supported by both rollers and one or more air bearings during the redirecting. Rollers may be suitable for applications where stringent property controls are not required of the resultant glass products.

In accordance with FIG. 2, once the glass ribbon has been turned from traveling in first direction 50 to traveling in second direction 52, the glass ribbon enters a bath of molten metal 58 contained within a suitable vessel 60, where the glass ribbon is supported on an exposed surface of the molten metal bath. The metal comprising the molten metal bath may be, for example, tin. In other embodiments the molten metal bath comprises tin in combination with one or more of lead, silver, antimony, copper or zinc. Additive metals, such as lead, silver, antimony, copper or zinc in suitable amounts can be used to lower the melting temperature of the molten metal bath. The temperature of the bath is preferably maintained below about 750° C. but above the melting temperature of the metal. For example, for a pure tin bath the temperature of the tin should be maintained equal to or greater than about 230° C., although as described above, the molten metal bath may be alloyed to achieve a somewhat lower temperature. To prevent oxidation of the molten metal, vessel 60 is provided with a cover 62 for maintaining a relatively inert atmosphere 64 above the molten metal. For example, an atmosphere of nitrogen, or a mixture of nitrogen and argon, forms a suitable inert atmosphere over the molten metal. It should be noted that cover 62 need not be gas tight, and arrangements can be made to periodically or continuously replace or supplement the inert atmosphere with a supply of suitable gases.

Preferably, the glass ribbon has a viscosity of at least 10⁹ Poise at it enters onto the surface of the molten metal bath 58, and preferably equal to or greater than about 10¹⁰ Poise. However, in some embodiments the glass ribbon may have a higher viscosity as it enters onto the surface of the molten metal bath, such as 10¹¹ poise. As the relatively hot glass ribbon travels over the surface of the molten metal bath, the temperature of the glass ribbon decreases to a temperature within a range of the molten metal bath. For example, a temperature of the molten metal bath in some embodiments is in a range from about 230° C. to about 750° C., resulting in a subsequent increase in the viscosity of the glass ribbon. Preferably, a viscosity of the glass ribbon upon leaving the molten metal bath is equal to or greater than about 10¹³ Poise, equal to or greater than about 10¹⁴ Poise or equal to or greater than about 10¹⁵ Poise and in some instances the viscosity of the glass ribbon leaving the molten metal bath is at least about 10¹⁶ Poise.

To ensure proper cooling of the glass ribbon as it traverses over the surface of the molten metal bath, heaters 57 may be immersed within the bath so that the bath exhibits a temperature gradient along the length of the bath, with the highest temperature at the inlet end of the bath where the glass ribbon enters, and the lowest temperature at the opposite exit end of the bath where the glass ribbon exits the bath. In some embodiments, the bath may also include submerged baffles 63 to aid in segregating regions of the bath from other regions of the bath, thereby limiting intermixing. Heaters and baffles may be used in conjunction with one another if necessary or desired. Proper cooling in the context of the present invention means to prolong the cooling period over the most important temperature range. That is, the temperature range over which the most impact can be made on the compaction of the glass. For a glass suitable for use in a display application, this is a temperature range equivalent to a glass viscosity between about 10¹¹ Poise and 10¹⁴ Poise.

It should be noted that in the instance where an individual glass sheet is floated on the molten metal bath rather than a continuous glass ribbon as described above, the individual glass sheet entering onto the hottest portion of the molten metal bath may be heated by the molten metal bath to a temperature much higher than the initial temperature of the glass sheet prior to the floating. In this case, the glass sheet is first raised to a first temperature substantially equal to the hot end of the molten metal bath then subsequently cooled as the glass sheet traverses the length of the molten metal bath toward the cooler end. In some embodiments the glass sheet may be preheated to a temperature the same or substantially the same as the temperature of the molten metal bath at the entry point of the glass sheet.

The glass ribbon may be moved over the surface of molten metal bath 58 by rollers 65 if necessary. As shown in FIG. 2, rollers 65 are positioned over the horizontally-deployed glass ribbon so that the rollers preferably contact only the edge portions of the glass ribbon (or glass sheet) to prevent damage to the quality region of the glass ribbon. Once the glass ribbon leaves the molten metal bath, the glass ribbon may be separated (i.e. cut) by conventional methods to form an individual glass sheet 66. For example, individual sheets of glass may be separated from the glass ribbon by separator 68. Separator 68 may, for example, comprise a score wheel or other mechanical scoring device that scores the glass ribbon. The glass ribbon may then be separated by applying a tensile stress across the score, such as by bending. In some embodiments, separator 68 comprises a mechanical scoring device as described supra, and a laser that traverses a laser beam over the score line and propagates a crack across the glass ribbon. In still other embodiments, separation can be achieved without mechanical scoring, wherein separator 68 comprises one or more lasers that score and separate the glass. Additionally a water jet and/or laser assisted water jet may be used to separate a sheet of glass from the glass ribbon.

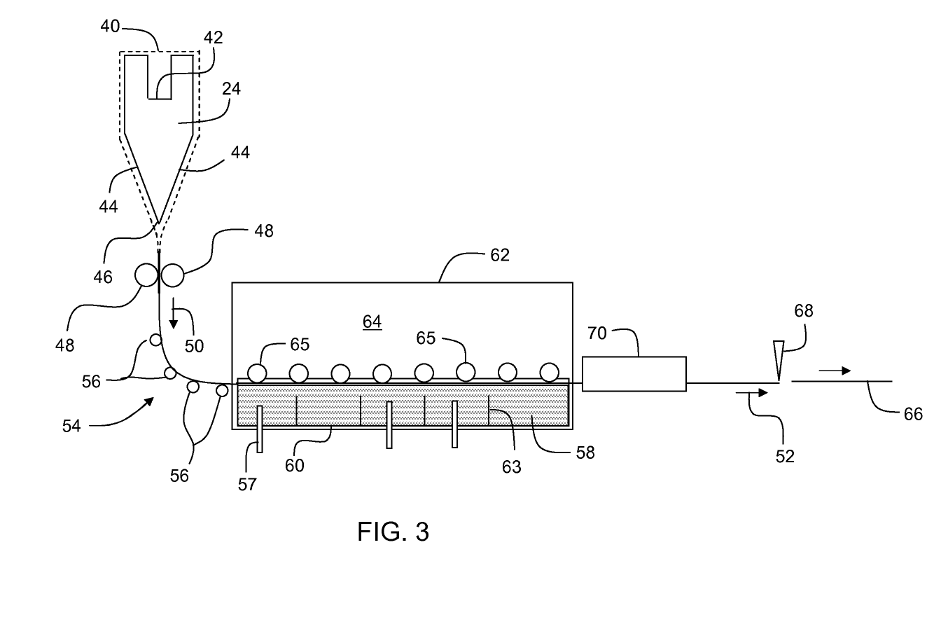

In some instances, the separated glass sheets or the glass ribbon, may be subjected to an optional further thermal treatment in thermal treatment chamber 70. For example, although thermal treatment chamber 70 is shown after the separation step of the process in FIG. 2 (i.e. after separator 68), thermal treatment chamber 70 may be positioned between the molten metal bath and separator 68 as illustrated in FIG. 3 so that the glass ribbon is further thermally treated after being removed from the molten metal bath. The additional thermal treatment in thermal treatment chamber 70 increases the period of time available for thermally treating the glass ribbon (or glass sheets derived therefrom), while overcoming the expense and complexity associated with maintaining a suitable temperature gradient within a molten metal bath.

Once glass sheet 66 has been separated from ribbon 26, glass sheet 66 may be subjected to an ion exchange process. For example, the glass sheet may be placed in a liquid bath (not shown) comprising potassium ions, wherein potassium ions in the ion exchange bath are substituted for, for example, sodium ions within the glass. Ion exchange processes are well known in the art and are not further described. More generally, the goal of the ion exchange process is to substitute larger ions for smaller ions, and ionic materials other than potassium may be used depending on the specific glass composition. One skilled in the art can easily determine a suitable ion exchange process depending on the composition of the glass sheet.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of forming a glass sheet comprising
flowing molten glass from a forming body in a down draw process in a first direction to form a glass ribbon comprising a viscous portion having a first viscosity equal to or greater than 10⁸ Poise;
redirecting the viscous portion to a second direction different from the first direction;
supporting the redirected viscous portion on a bath of molten metal, wherein a second viscosity of the viscous portion as it enters onto the bath of molten metal is equal to or greater than about 10⁹ Poise;
cooling the viscous portion to a third viscosity equal to or greater than about 10¹⁴ Poise as the viscous portion traverses the bath of molten metal to form an elastic portion; and
separating the elastic portion to form an individual glass sheet.

2. The method according to claim 1, wherein the third viscosity is equal to or greater than 10¹⁵ Poise.

3. The method according to claim 1, wherein the third viscosity is equal to or greater than 10¹⁶ Poise.

4. The method according to claim 1, wherein the bath of molten metal comprises tin.

5. The method according to claim 4, wherein the bath of molten metal comprises lead, silver, copper, zinc or antimony.

6. The method according to claim 1, further comprising ion exchanging at least one surface of the glass sheet after the separating.

7. The method according to claim 1, wherein the viscous portion is supported by an air bearing during the redirecting.

8. The method according to claim 1, wherein the viscous portion of the glass sheet is supported by rollers during the redirecting.

9. The method according to claim 1, wherein the first viscosity is equal to or greater than 10⁹ Poise.

10. The method according to claim 1, wherein the first viscosity is equal to or greater than 10¹⁰ Poise.

11. The method according to claim 1, further comprising thermally treating the glass ribbon after the cooling.

12. A method of heat treating a glass sheet comprising:
providing a glass sheet, the glass sheet having a viscosity greater than 10⁹ Poise; and
supporting the glass sheet on a bath of molten metal, wherein the glass sheet is thermally treated for a time effective to reduce a fictive temperature of the glass sheet below a predetermined temperature.

13. The method according to claim 12, wherein the fictive temperature of the glass sheet after the heating is between 230° C. and 650° C.

14. An apparatus for producing a glass sheet comprising:
a forming body comprising a channel formed in an upper surface thereof for receiving molten glass, and converging forming surfaces that join at a root;
a redirecting apparatus configured to redirect a glass ribbon descending from the root from a first direction to a second direction different than the first direction;
a vessel containing a molten metal configured to support the glass ribbon; and
a cutting device positioned downstream of the vessel and adapted to cut a glass sheet from the glass ribbon.

15. The apparatus according to claim 14, wherein the redirecting apparatus comprises an air bearing.

16. The apparatus according to claim 14, wherein the redirecting apparatus comprises rollers.

17. The apparatus according to claim 14, wherein the molten metal is tin.

18. The apparatus according to claim 14, wherein the molten metal comprises a metal selected from the group consisting of tin, lead, silver, antimony, copper and zinc, or combinations thereof.

19. The apparatus according to claim 14, wherein the apparatus further comprises a thermal treatment chamber positioned between the molten metal containing vessel and the cutting device.

20. The apparatus according to claim 14, wherein the apparatus further comprises a thermal treatment chamber.
